(19) United States
(12) Patent Application Publication
(10) Pub. No.: US 2003/0037020 A1
(43) Pub. Date: Feb. 20, 2003

(54) Method and apparatus for synchronizing databases of portable devices without change logs

(76) Inventors: Lars Novak, Bjarred (SE); Jorgen Birkler, Malmo (SE); Carl Gustavsson, Lund (SE)

Correspondence Address: BURNS DOANE SWECKER & MATHIS L L P, POST OFFICE BOX 1404, ALEXANDRIA, VA, 22313-1404, US

(21) Appl. No.: 09/507,686

(22) Filed: Feb. 22, 2000

(51) Int. Cl. G06F 7/00

(52) U.S. Cl. 707/1

(57) ABSTRACT

Methods, systems and devices for synchronizing corresponding databases in electronic devices are described. Techniques according to the present invention perform synchronization without the need for change logs, thereby freeing valuable memory space. A checksum is calculated on the contents of the stored database and replaces the database identifier (DID). The receiving device checks the DID to determine if an update is necessary and, if so, performs a record-by-record comparison of the corresponding databases.

### BACKGROUND

The present invention relates generally to communications systems and, in particular, to techniques which provide for synchronizing databases, e.g., a database containing a phonebook stored in a subscriber identity module (SIM) of a mobile station used in a cellular radiocommunication system with a corresponding database in a personal computer (PC).

The cellular telephone industry has made phenomenal strides in commercial operations in the United States as well as the rest of the world. Growth in major metropolitan areas has far exceeded expectations and is rapidly outstripping system capacity. If this trend continues, the effects of this industry's growth will soon reach even the smallest markets. Innovative solutions are required to meet these increasing capacity needs as well as maintain high quality service and avoid rising prices.

One recognized trend is the convergence of the so-called information industry, as symbolized by the evolution of the PC, and the so-called communications industry, as symbolized by the evolution of the mobile phone. Both types of devices are characterized by rapidly increasing performance (hardware) and by increased application (software) capabilities. In the near future, it is likely that mobile phones will communicate more directly with other information devices, such as the PC, to exchange information. Many subscribers of wireless services also own personal computers and, as each type of device gets more sophisticated in its data handling capability, may wish to exchange data therebetween, e.g., between databases (such as phone books), stored in each device.

Consider the example illustrated in FIG. 1. Therein, a PC 10 and a mobile phone 20 are linked together via communication link 30. It will be appreciated by those skilled in the art that while a PC and mobile phone are used as examples of two devices between which database synchronization may be performed that the present invention is not limited to these two types of devices and may, in fact be applied to database synchronization between any two types of devices e.g., electronic organizers, pagers, etc. The PC 10 includes a database 40, e.g., containing phone records or a calendar, while the mobile phone 20 includes a corresponding database stored on its subscriber identity module (SIM) card 50. As will be appreciated by those skilled in the radiocommunication arts, the SIM card is a removable smart card that was created for the GSM radiocommunication standard as a mechanism to conveniently group and store information elements related to the mobile subscriber in a removable manner, which card is insertably removable from mobile phones. The term “synchronize” as it is used herein to refer to database operations associated with two or more devices means changing the contents of one database so that it mirrors the contents of the other database.

Conventionally, to synchronize the database 40 and the database stored on SIM card 50, it was necessary to individually compare each record in each database. For example, the database of phonebook records stored in SIM card 50 could be transmitted to PC 10 via link 30. Then, the records in each database could be compared and updated such that the two databases mirrored one another. Changes to the database stored in the SIM card 50, e.g., associated with records found in the database 40 but not found in the version of the database transmitted from the mobile phone 20 to the PC 10, could then be relayed back to the mobile phone 20 to update the SIM card's phonebook. This synchronization process (sometimes referred to as “full synchronization”) is complicated and time consuming.

To address this problem, a change log has been added to the devices as shown in FIG. 2. The change log contains information regarding records which have been operated upon in either database subsequent to synchronization therebetween. The change log can be implemented, for example, in a portion of memory which records for each change an event (e.g., add, delete or modify), the identity of the database record for which the event occurred and a timestamp indicating when the event took place. For example, if a phone record is added to database 40 in PC 10 subsequent to it being synchronized with mobile phone 20, then an indication of such will be found in change log 200. Likewise, if the subscriber associated with mobile phone 20 (and SIM card 50) deletes a record in his or her phonebook, then this change will be reflected in change log 205. Moreover, if the change log is empty, then no changes need to be made to the database in the PC. Using change logs 200 and 205 may be advantageous during synchronization since only those records which have been modified, added or deleted (as recorded in the change log) since the last synchronization update need to be transmitted between the devices. Thus, the synchronization process may be performed more rapidly and this process has, therefore, been referred to as “fast synchronization”.

Under certain circumstances, however, it may still be desirable to perform full synchronization of corresponding databases in two devices even when change logs have been implemented to enable fast synchronization. For example, if a user resets or erases his or her calendar database in a mobile phone, such an action may dictate that a full synchronization be performed between the two databases, i.e., there is no particular advantage in such cases to using the change logs 200 and 210 to accomplish synchronization. Invoking full synchronization of two databases when fast synchronization is available has been accomplished by, for example, randomly or incrementally changing the value of a database identifier (DID) which is passed between the devices as part of the synchronization process. The change in DID values tells the device performing database synchronization to use full synchronization as opposed to fast synchronization. The receiving device, e.g., a PC, will compare the DID received from the other device, e.g., a mobile phone, with a DID which it previously stored. If they are the same, then fast synchronization will be used. If they are different, then full synchronization is performed.

Unfortunately, although it may speed up the synchronization process, adding the change logs introduces another problem. Memory on the SIM card 50 is extremely limited. Thus, it is likely that the change log will be stored in another memory device in the mobile phone 20, e.g., local RAM (not shown), rather than on the SIM card 50 itself, as is the database. This may be problematic when the SIM card 50 is transferred to another mobile phone as depicted in FIG. 3. In this example, consider that SIM card 50 has been transferred from mobile phone 20 to mobile phone 300, e.g., the subscriber of mobile phone 20 has borrowed mobile phone 300. Then, the subscriber makes a change to his or her phonebook while using mobile phone 300. This change is reflected in change log 305, but not in change log 210. After re-installing SIM card 50 into mobile phone 20, the subscriber initiates the synchronization process, however since change log 210 does not include the change or changes made to the database in the SIM card 50, the PC cannot be updated with those changes.

Accordingly, it would be desirable to provide techniques and apparatuses which enable the usage of change logs for synchronizing databases, but also accommodate the portability of SIM cards and the like.

### SUMMARY

These and other drawbacks of conventional techniques are overcome according to exemplary embodiments of the present invention, wherein change logs are eliminated. Instead, whenever a database in a first device is changed, that database's identifier is also changed. Then, when the version of the database stored in the first device is to be synchronized with a corresponding database in a second device, a comparison of database identifiers is performed. If the version of the database identifier stored in the second device matches the version of the identifier stored in the first device, then no updating is necessary and the synchronization process ends. If, on the other hand, the two versions of the database identifier do not match, then the second device recognizes that the database stored in the first device is different than its version of the database and a slow synchronization (i.e., a record-by-record comparison) of the two databases is performed.

In this way, database synchronization can be performed without the need for change logs, which reduces memory requirements associated with database synchronization and avoids the problems described above associated with change logs and SIM card swapping between mobile phones.

### BRIEF DESCRIPTION OF THE DRAWINGS

The above objects and features of the present invention will be more apparent from the following description of the exemplary embodiments with reference to the accompanying drawings, wherein:

FIG. 1 illustrates a conventional technique for synchronizing databases between devices;

FIG. 2 illustrates a modification of the technique and system of FIG. 1, wherein change logs are introduced into each device for synchronizing the database;

FIG. 3 depicts the problem associated with using change logs when a SIM card is moved between devices;

FIG. 4 is a block diagram illustrating various components of an exemplary cellular radiocommunication system;

FIG. 5A is a flowchart illustrating a conventional technique for changing a DID value after the occurrence of a predetermined event;

FIG. 5B is a flowchart depicting an exemplary conventional method for synchronizing databases;

FIG. 6A is a flowchart showing an exemplary technique for changing a DID value to be a checksum associated with the contents of the database according to the present invention; and

FIG. 6B is a flowchart illustrating an exemplary method for synchronizing databases according to the present invention.

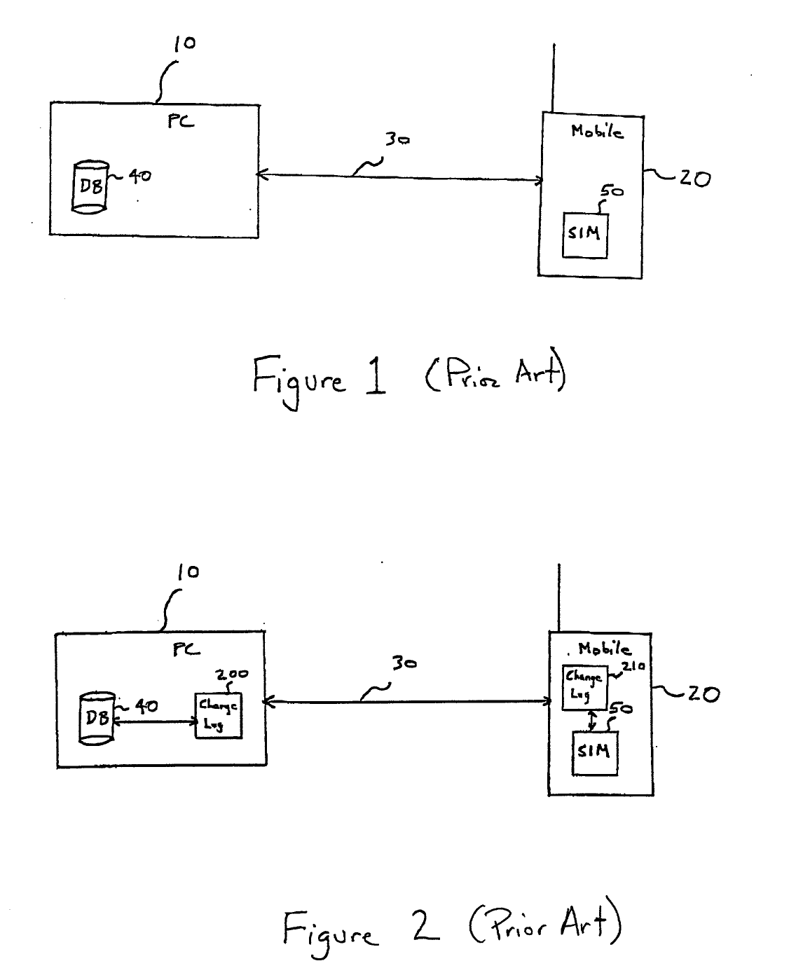

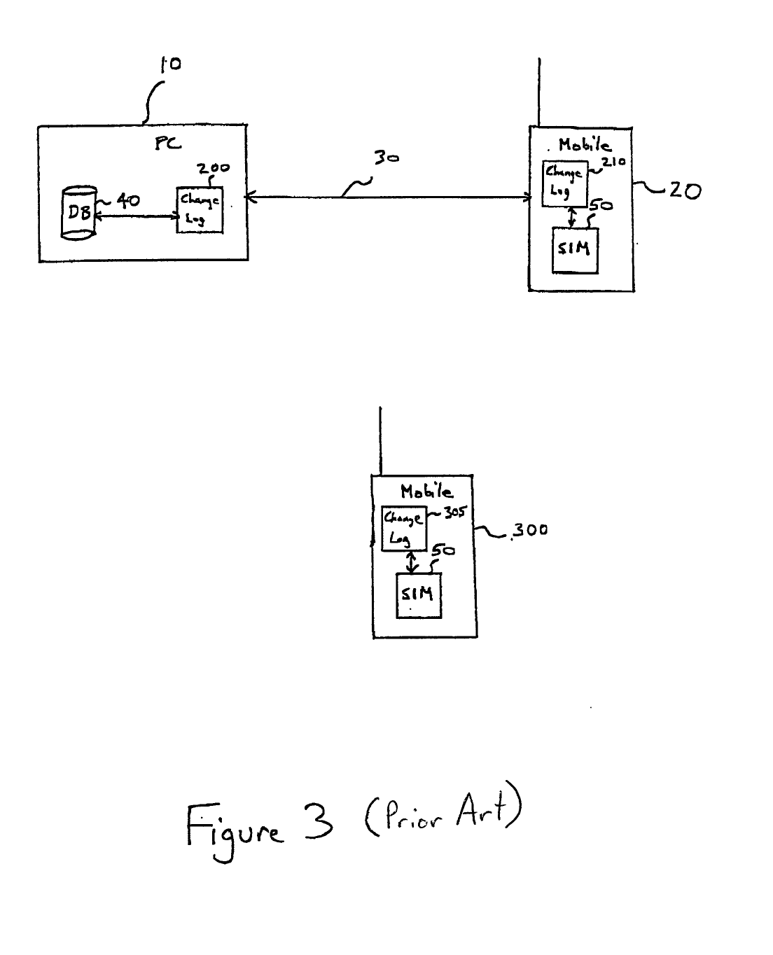

### DETAILED DESCRIPTION

The following description is written in terms of a cellular radiotelephone system, but it will be understood that Applicants' invention is not limited to that environment. More specifically, the following description is written using terms which may be associated with GSM compliant systems, e.g., terminals employing SIM cards, but it will be understood by those skilled in the art that the present invention may be implemented in other communication/information handling applications including those which are designed in accordance with other standards, e.g., IS-95 or PDC, as well as those which use other access methodologies, e.g., CDMA. Moreover, the following techniques are also applicable to synchronizing databases between any two information/communication devices.

As mentioned above, however, the present invention finds particular application to the synchronization of databases between devices wherein at least one of the devices has a removable SIM card, e.g., a mobile phone. Those skilled in the art will be familiar with details regarding SIM cards per se, which details are, therefore, not repeated here. However, the interested reader is referred to the document entitled “Specification of the Subscriber Identity Module-Mobile Equipment (SIM-ME) Interface”, GSM 11.11, Version 4.10.0, dated Jan. 21, 1994, the disclosure of which is incorporated here by reference, for a discussion of SIM card specifications.

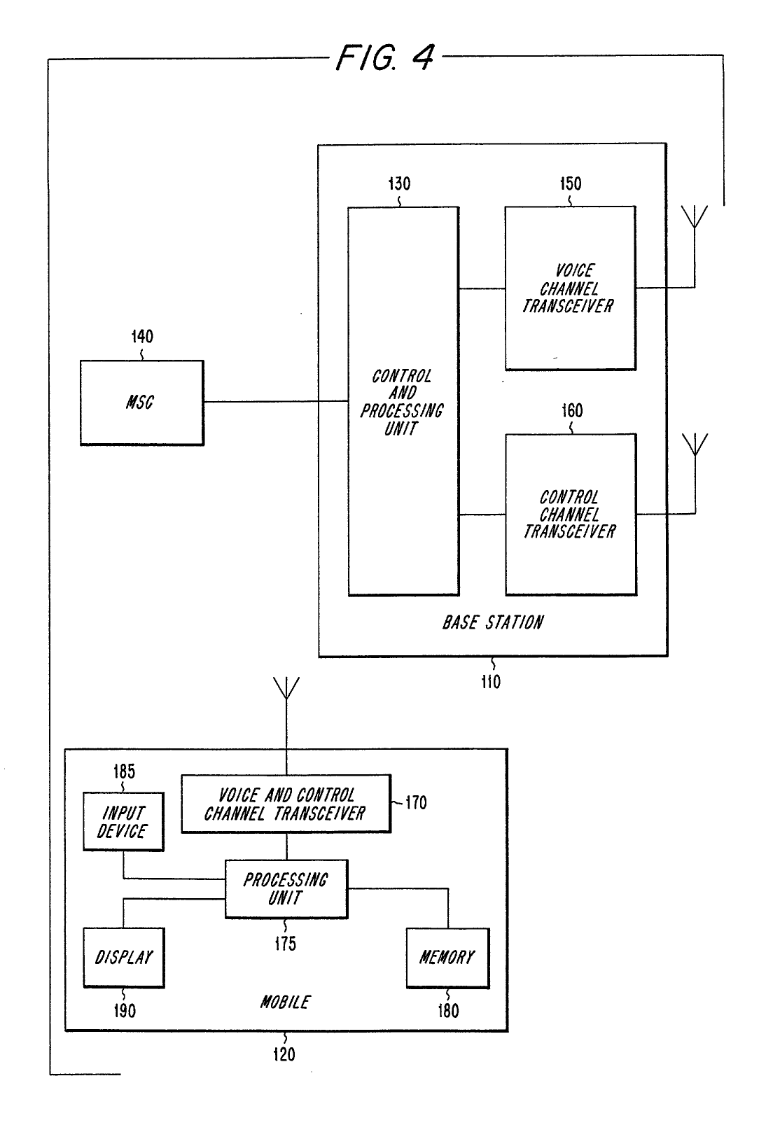

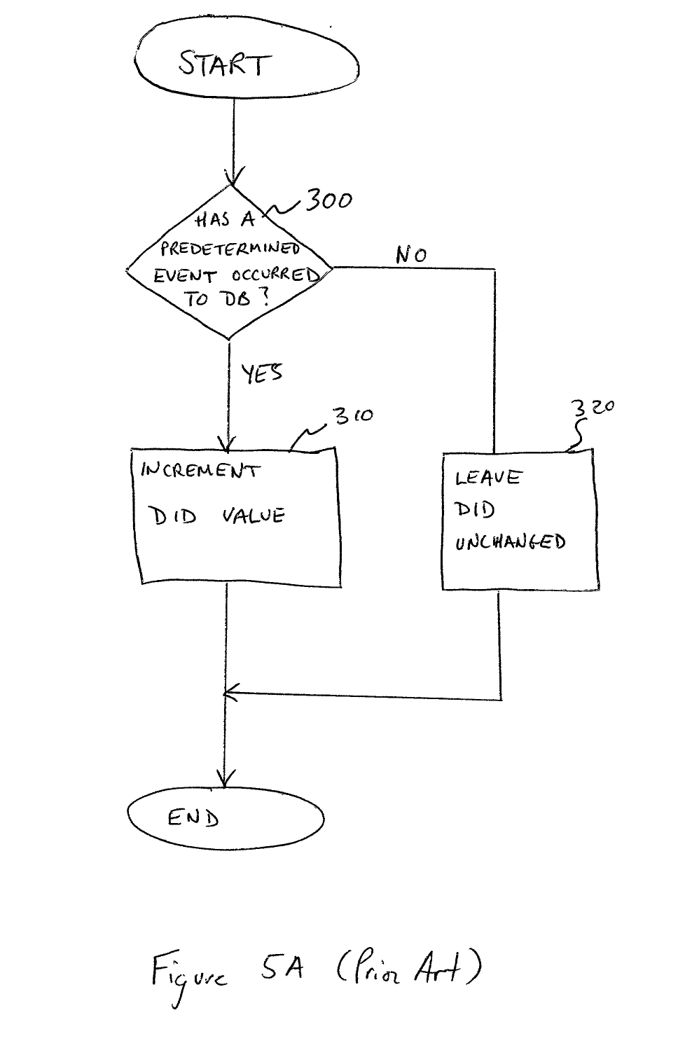

FIG. 4 represents a block diagram of an exemplary cellular mobile radiotelephone system, including an exemplary base station 110 and mobile station 120, mobile stations being examples of devices having databases which can be synchronized according to the present invention. The base station includes a control and processing unit 130 which is connected to the MSC 140 which in turn is connected to the PSTN (not shown). General aspects of such cellular radiotelephone systems are known in the art, as described by U.S. Pat. No. 5,175,867 to Wejke et al., entitled “Neighbor-Assisted Handoff in a Cellular Communication System,” which is incorporated in this application by reference.

The base station 110 handles a plurality of voice channels through a voice channel transceiver 150, which is controlled by the control and processing unit 130. Also, each base station includes a control channel transceiver 160, which may be capable of handling more than one control channel. The control channel transceiver 160 is controlled by the control and processing unit 130. The control channel transceiver 160 broadcasts control information over the control channel of the base station or cell to mobiles locked to that control channel. It will be understood that the transceivers 150 and 160 can be implemented as a single device, like the voice and control transceiver 170, for use with DCCHs and DTCs that share the same radio carrier frequency.

The mobile station 120 receives the information broadcast on a control channel at its voice and control channel transceiver 170. Then, the processing unit 175 evaluates the received control channel information, which includes the characteristics of cells that are candidates for the mobile station to lock on to, and determines on which cell the mobile should lock. Advantageously, the received control channel information not only includes absolute information concerning the cell with which it is associated, but also contains relative information concerning other cells proximate to the cell with which the control channel is associated, as described in U.S. Pat. No. 5,353,332 to Raith et al., entitled “Method and Apparatus for Communication Control in a Radiotelephone System,” which is incorporated in this application by reference.

The mobile station 120 also includes an input device 185, such as a numeric keypad, which allows a user to interact with the mobile station. A display device 190, such as an LCD screen, provides a visual display of information to the user. The mobile station also includes memory 180 which may include, for example, one or more databases which store information relating to a phonebook, a calendar, etc., which can be accessed by the user. Moreover, memory 180 can be a removable memory structure, such as a smart card, SIM card, etc.

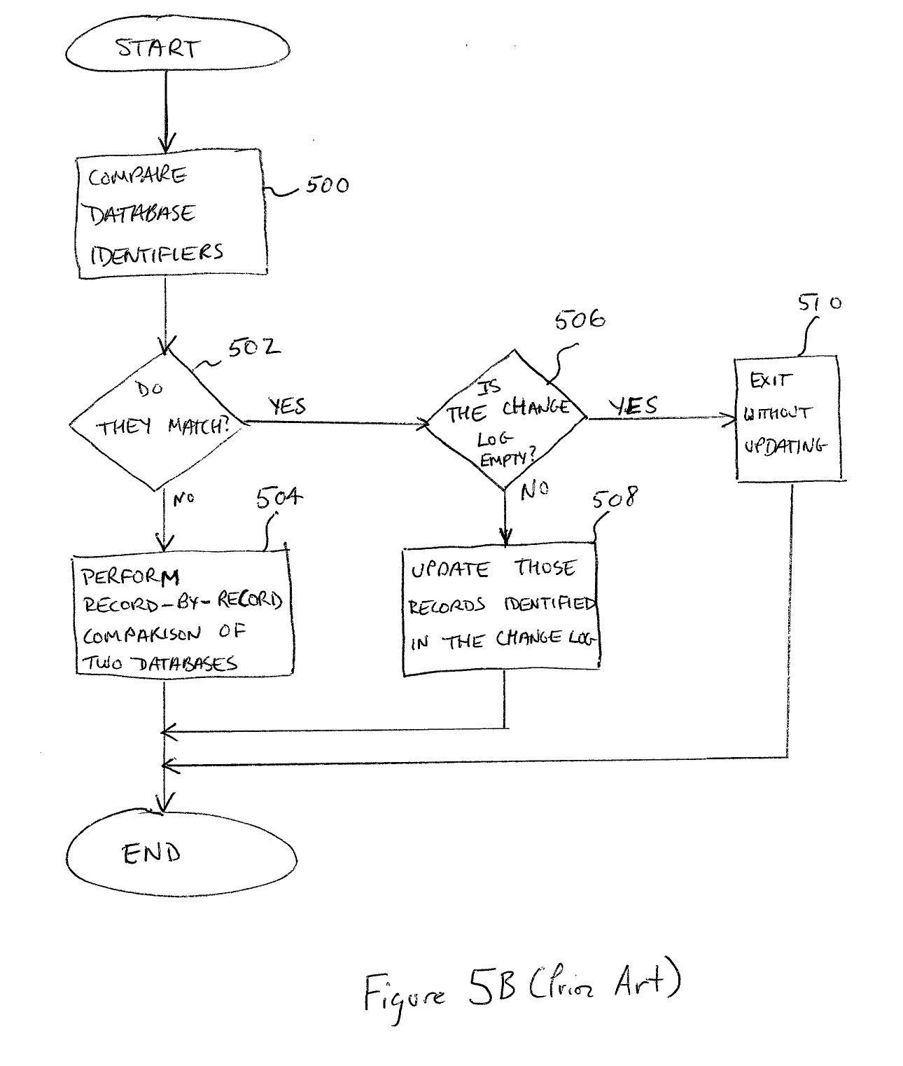

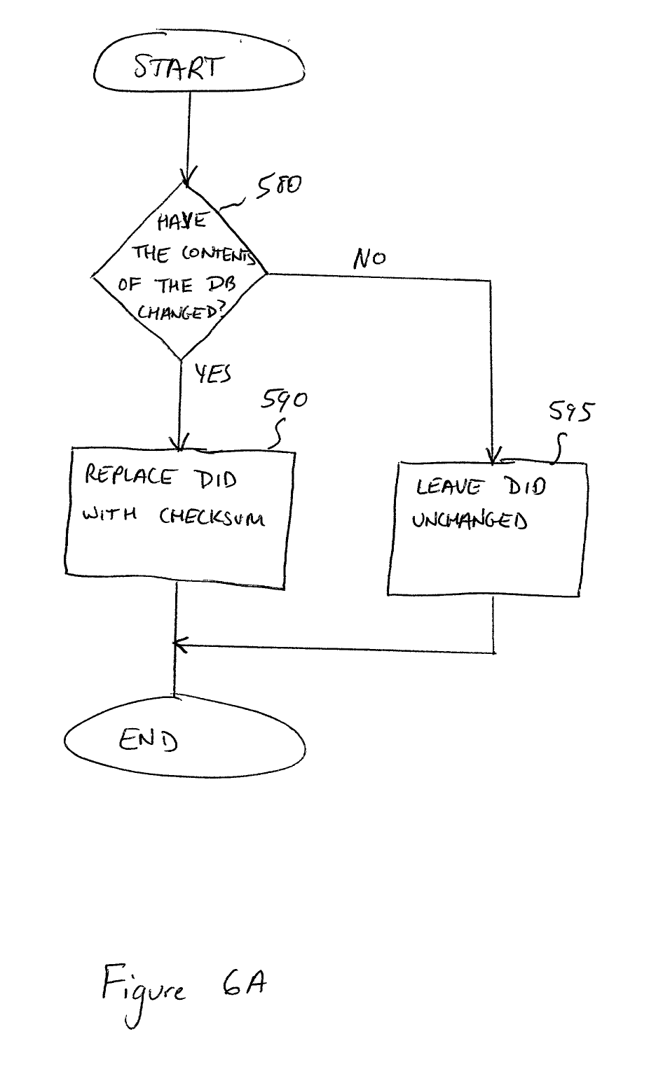

As described above, conventional techniques for synchronizing databases employ change logs to facilitate faster synchronization under certain circumstances, but also permit full synchronization upon the occurrence of a predetermined event (e.g., resetting of a database). FIG. 5A depicts the steps associated with changing a DID value to trigger full synchronization. Therein, at step 300, the device having a database determines whether a predetermined event has occurred. If so, then the DID value is changed at step 310, e.g., randomly or incrementally, to subsequently trigger full synchronization when a synchronization process is initiated. Otherwise, the DID value remains the same at step 320 so that the change log will be used to perform fast synchronization.

FIG. 5B is a flowchart which illustrates conventional synchronization functionality using the DID value which has been determined in accordance with FIG. 5A. Therein, starting at block 500, the receiving device, e.g., a PC, will compare the DID received from the other device, e.g., a mobile phone, with a DID which it previously stored. If they are different, as determined at decision block 502, then full synchronization is performed at block 504. If they are the same, then the process moves to block 506 wherein the change log is examined. If the change log contains changes, then the flow moves to block 508 wherein a fast synchronization is performed by updating only those records which have been identified in the change log has having been modified. If the change log is empty, then the process moves instead from block 506 to block 510 wherein it is determined that the database in the receiving device is identical to the database stored in the other device so that no updating of the database in the receiving device is necessary.

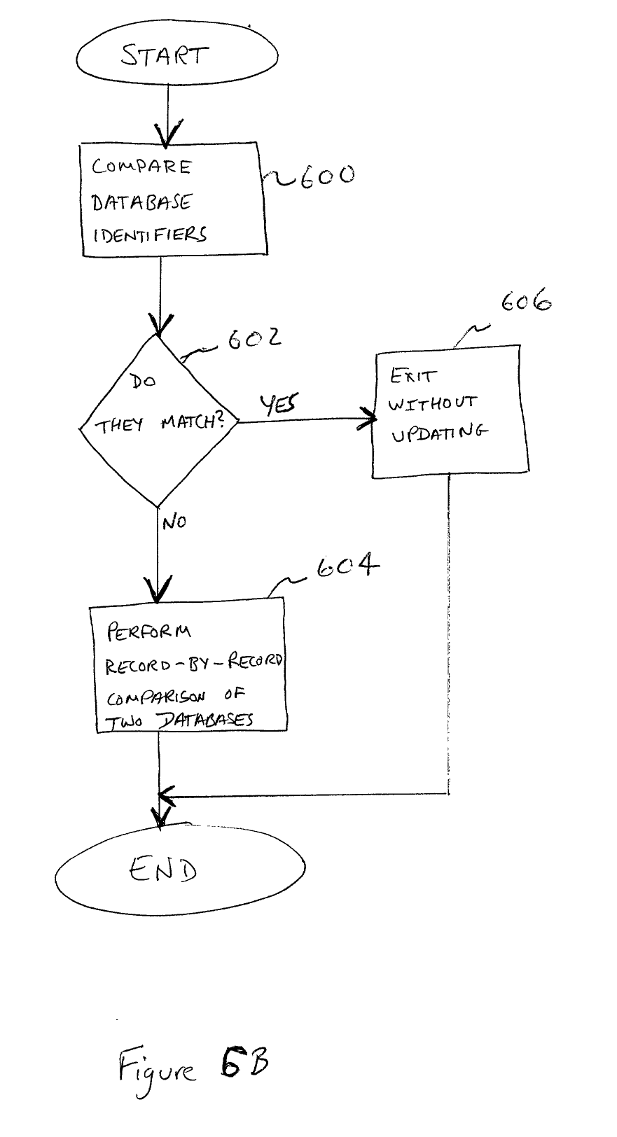

This conventional technique, however, requires the use of change logs which, in turn, use valuable memory space and pose other problems described above. Thus, according to exemplary embodiments of the present invention, change logs are eliminated and the DID is used to determine if changes have been made to the database such that updating is needed. An example of this process will now be described with respect to FIGS. 6A and 6B.

As shown in FIG. 6A, in the device containing the database, e.g., a mobile phone, the DID can be replaced by a checksum associated with the contents of the database. The calculation of checksums per se is well known in the art and any known type of checksum calculation can be employed, for example a cyclic redundancy check known as CRC-16 can be used over the entire database. The calculation of the checksum as the DID can be performed at various times. For example, according to one exemplary embodiment, when the database is modified, e.g., a record is added, deleted or modified, a new checksum is calculated as shown by steps 580 and 590. The checksum (e.g., 2 bytes/phonebook) will, therefore, change whenever the database is modified. The calculated checksum can then be stored and used to aid in tracking changes to the database stored in the memory 180, e.g., a SIM card.

However, the checksum can be calculated and stored in the device as the DID at other times. Examples include: when a receiving device requests the change log or DID for purposes of synchronization, at startup (power-on) of the device, or periodically. If performed periodically, then step 595 serves to maintain the value of the DID when a periodic check indicates that the database has not been modified. Those skilled in the art will appreciate that the calculation of the checksum and replacement of the DID value with the newly calculated checksum can occur at any other times not specifically recited here.

When the device communicates with a receiving device to perform, among other things, database synchronization, the DID from this device can be passed to the receiving device and used as described in FIG. 6B. The database identifiers can be compared (block 600) to determine if they match (block 602). If not, then a full (slow) synchronization can be performed at step 604 to compare, on a record-by-record basis, the two databases and update them as necessary so that they are identical (or substantially identical). If the DIDs match, then no changes have been made to the database subsequent to the last synchronization of the two databases and the process can end without changing the version of the database stored in the receiving device at step 606.

Thus, it will be appreciated by those skilled in the art that the present invention provides techniques for synchronizing databases in electronic devices which avoids the need for change logs. Unlike conventional techniques, the DID stored in one of the devices is replaced by a checksum associated with the contents of the database. Then, whenever the DID contained in one device is different than the DID contained in another device, a full synchronization is performed.

While the present invention has been described with respect to certain exemplary embodiments, one skilled in the art will appreciate that the invention would equally apply to other such systems. The present invention is applicable to many different types of electronic devices which employ databases. For example, portable radio devices, personal digital assistants and communicators, electronic organizers, communicators, pagers, smart phones, etc., can all employ techniques and structures according to the present invention. Many variants and combinations of the techniques taught above may be devised by a person skilled in the art without departing from the spirit or scope of the invention as described by the following claims.

What is claimed is:

1. A method for synchronizing a first database in a first device with a second database in a second device comprising the steps of:
calculating a first database identifier value based on contents of said first database by said first device;
comparing said first database identifier with a second database identifier stored in said second device;
performing no update of said second database when said first and second database identifiers match; and
updating, whenever said first database identifier is different than said second database identifier, each record associated with said second database using a corresponding record in said first database.

2. The method of claim 1, wherein said first device is a mobile phone and said second device is a computer.

3. The method of claim 1, wherein said first and second databases are phonebook databases.

4. The method of claim 1, wherein said step of calculating is performed when a change log is requested from said first device by said second device.

5. The method of claim 1, wherein said step of calculating is performed periodically.

6. The method of claim 1, wherein said step of calculating is performed at startup of said first device.

7. The method of claim 1, wherein said step of calculating is performed whenever a change is made to said first database.

8. The method of claim 1, wherein said first database identifier value is a checksum calculated as a cyclic redundancy check (CRC).

9. The method of claim 8, wherein said CRC is CRC-16.

10. The method of claim 8, wherein said CRC is CRC-32.

11. An electronic device comprising:
a memory for storing a database; and
a processor for calculating a checksum associated with said database and storing said checksum as a database identifier.

12. The electronic device of claim 11, wherein said electronic device does not include a change log which records modifications made to said database.

13. The electronic device of claim 11, wherein said processor calculates said checksum when a change log is requested from said first device by said second device.

14. The electronic device of claim 11, wherein said processor calculates said checksum periodically.

15. The electronic device of claim 11, wherein said processor calculates said checksum at startup of said electronic device.

16. The electronic device of claim 11, wherein said processor calculates said checksum startup performed whenever a change is made to said first database.

17. The electronic device of claim 11, wherein said checksum calculated as a cyclic redundancy check (CRC).

18. The electronic device of claim 17, wherein said CRC is CRC-16.

19. The electronic device of claim 17, wherein said CRC is CRC-32.
